(19) United States
(12) Patent Application Publication
(10) Pub. No.: US 2013/0190119 A1
(43) Pub. Date: Jul. 25, 2013

(54) Chain Guard Housing

(71) Applicants: Antony Barnes, Stockport (GB); Andrew Greening, Sandbach (GB)

(72) Inventors: Antony Barnes, Stockport (GB); Andrew Greening, Sandbach (GB)

(73) Assignee: LOUVER-LITE LIMITED, Hyde, CH (UK)

(21) Appl. No.: 13/699,483

(22) PCT Filed: May 26, 2011
(86) PCT No.: PCT/GB11/00813

§ 371 Date: Apr. 3, 2013

(30) Foreign Application Priority Data
May 27, 2010 (GB) 1008899.5

(51) Int. Cl. F16H 57/031

(52) U.S. Cl. CPC F16H 57/031
USPC 474/144

(57) ABSTRACT

A chain guard housing for a blind, the housing including a body portion and a chain cover portion hingedly coupled to the body portion, whereby the chain cover portion is capable of being rotated about the hinge out of alignment with a chain sprocket.

The present invention relates to chain guard housings and in particular to chain guard housings for use with blinds. It also relates to blind control units and roller blinds including such chain guard housings.

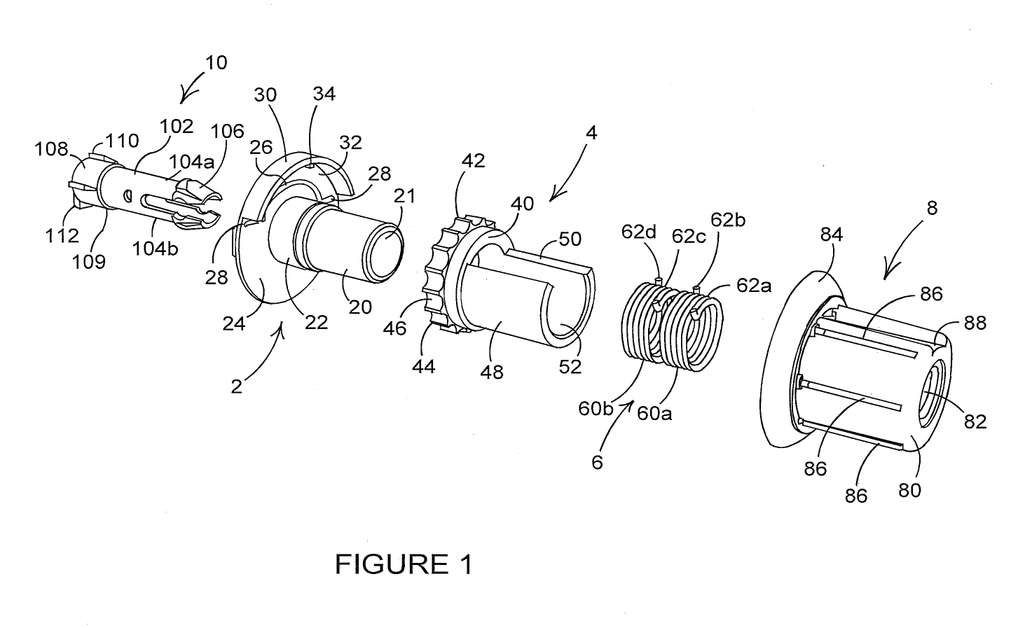

Chain guard housings typically include a cover element which overlies in use a part of a chain sprocket (also known as a chain wheel or drive sprocket) so as to prevent an operating chain of the blind from jumping out of engagement with the chain sprocket. Conventionally, chain guard housings are fixed relative to a sprocket support part of a blind control unit. A description of such conventional control units is provided in the prior art discussions of GB2392703 in conjunction with FIGS. 1a-d, 2a and 2b.

The conventional control unit requires it to be dismantled in order to engage the operating chain with the sprocket wheel. However, dismantling the control unit is time consuming and many blind assemblers try to save time by forcing the operating chain between the chain guard housing and the chain sprocket in order to engage the operating chain with the sprocket wheel without having to dismantle the control unit. Such actions risk causing damage to the chain sprocket, the chain guard housing and/or the operating chain.

GB2392945 proposed a solution to the above-mentioned problems with conventional blind control units in the form of a control unit in which the chain guard housing is rotatable relative to the sprocket support. However, the inventors of the present invention propose an alternative arrangement in order to address the problems with known blind control units.

According to a first aspect, the present invention provides a chain guard housing for a blind, the housing including a body portion and a chain cover portion hingedly coupled to the body portion, whereby the chain cover portion is capable of being rotated about the hinge out of alignment with a chain sprocket. Thus, the chain guard housing includes a chain cover portion, a body portion and a hinge located therebetween which rotatably couples the chain cover portion to the body portion.

In use, the chain cover portion overlies a portion of the chain sprocket such that a gap or channel is defined therebetween, the gap being sized and configured to prevent disengagement of an operating chain from the chain sprocket.

Therefore, a blind assembler wishing to engage an operating chain with a chain sprocket need only to rotate the chain cover portion of the chain guard housing about the hinge until it is out of alignment with the chain sprocket (i.e. no longer covers a portion of the chain sprocket). The operating chain can then simply be dropped onto the chain sprocket and the chain cover portion of the chain guard housing can be rotated about the hinge back into alignment with the chain sprocket. With the chain cover portion in alignment with the chain sprocket (i.e. overlying at least a portion of the chain sprocket), the operating chain is trapped between the chain sprocket and the chain guard housing and is prevented or restrained from disengaging from the chain sprocket.

The various components of conventional blind control units are typically retained in the correct configuration by a centre pin, which effectively locks the components together. Thus, the body portion of the chain guard housing may define an aperture which is sized and configured to receive therein a centre pin. In embodiments where the chain guard housing includes a centre pin aperture, the hinges may be arranged such that they are upwardly spaced from an upper horizontal tangent relative to the aperture.

The skilled person will appreciate that reference to “horizontal”, “upper” and such like are intended to be construed as relating to the unit when installed for normal use. Thus, in use, the hinges may be located above the uppermost portion of the centre pin aperture, such that rotation of the chain cover portion of the chain guard housing does not foul the centre pin.

As the chain guard housing prevents the operating chain from disengaging from the chain sprocket, it is desirable to be able to releasably secure it when in alignment with the chain sprocket. Accordingly, in an embodiment of the invention as defined anywhere herein, the chain cover portion has a covered configuration in which at least part of the chain cover portion overlies a portion of a chain sprocket and an uncovered or exposed configuration in which it is spaced from the chain sprocket, and the chain cover portion includes a first lock element adapted to releasably retain the chain cover portion in the covered configuration.

The first lock element may releasably engage a second lock element carried by a component of a control unit. For example, the chain guard housing may cooperate with a second component of the blind, such as a drive bush, to prevent the release of the first lock element.

According to a second aspect of the invention, there is provided a chain drive arrangement for a window blind, the arrangement including a chain sprocket, a sprocket support, a chain guard housing and an operating chain, wherein the chain sprocket is rotatably coupled to the sprocket support, and wherein the chain guard housing includes a body portion and a chain cover portion hingedly coupled to the body portion such that the chain guard housing has (i) a covered configuration in which the chain cover portion overlies a portion of the chain sprocket and defines therebetween a gap or channel sized and shaped to permit the operating chain to rotate through the gap/channel when correctly engaged with the chain sprocket and to prevent or resist disengagement of the operating chain from the chain sprocket; and (ii) an uncovered configuration in which the chain sprocket is not covered by the chain cover portion (i.e. in which the chain cover portion is rotated away from the chain sprocket), thereby permitting the chain to be disengaged from the chain sprocket.

According to a third aspect of the invention, there is provided a blind control unit which includes a chain guard housing as defined anywhere herein, a chain sprocket and a sprocket support, wherein the chain sprocket is rotatably coupled to the sprocket support and the chain cover portion has a covered configuration in which is overlies at least a part of the sprocket. The chain guard housing may be connected to the sprocket support or it may form a part of the sprocket support.

The chain drive arrangement of the second aspect of the invention may form a part of the blind control unit of the third aspect of the invention.

In order to prevent unwanted movement of the control unit as a result of the weight of the blind fabric, the control unit suitably includes a clutch adapted to permit torque to be transmitted from the chain sprocket. The clutch is typically adapted to prevent torque being transmitted back to the chain sprocket by a blind operatively connected to the control unit. Thus, the clutch typically only allows torque to be transmitted to the blind and not from the blind. The clutch may be a wrap spring clutch, suitably including one or more wrap springs.

In embodiments in which the chain guard housing forms a part of the sprocket support, the chain guard housing and the sprocket support may form a one-piece construction. In this way, the number of component parts required to form the control unit is reduced, which decreases the unit costs and also the assembly time and effort.

In an embodiment of the invention as defined anywhere herein, the blind control unit further includes a drive bush operatively coupled to the chain sprocket, the drive bush being adapted to engage a roller tube. In order to simplify the control unit, the drive bush may be adapted to cooperate with the chain guard housing to prevent disengagement of an operating chain from the chain sprocket. Thus, the chain guard housing and the drive bush may together form a substantially enclosed housing portion for a part of an operating chain. Thus, the enclosed housing portion may include a chain inlet, a chain outlet and functions to prevent disengagement of the operating chain from the chain sprocket.

As mentioned above, the chain guard housing includes a cover portion which may have a covered configuration in which at least part of the chain cover portion overlies a portion of a chain sprocket, and an uncovered configuration in which it is spaced from the chain sprocket, and the chain cover portion may include a first lock element adapted to releasably retain the chain cover portion in the covered configuration. In such an embodiment, the first lock element may engage a second lock element defined by the blind control unit. For example, the second lock element may be carried by drive bush. As the drive bush is adapted to rotate relative to the chain guard housing, the second lock element may include an annular locking channel defined by a face of the drive bush, such that the first lock element may be retained within the second lock element even when the drive bush rotates relative to the chain guard housing. Where the second lock element is an annular locking channel, the locking channel may include an undercut and the first lock element may include a lug adapted to engage the undercut and resist the first lock element being disengaged unintentionally from the locking channel.

In a further embodiment of the invention as defined anywhere herein, the blind control unit further includes an operating chain which is engaged with the chain sprocket.

The control unit may be used with blinds such as roller blinds, vertical blinds, horizontal (Venetian) blinds, roman blinds and pleated blinds.

According to a fourth aspect of the invention, there is provided a roller blind including a control unit as described anywhere herein, an idle end and located therebetween a roller tube carrying a blind fabric or sheet.

The term “roller blind” is intended to cover all blind systems based around a rotating tube. These include conventional roller blinds, but also include blinds such as cellular blinds and Roman blinds that operate via a rotating tube.

Blind components are typically sold by the manufacturers to blind installers, who then take the components to build and install the blinds for the end user. Thus, according to a fifth aspect of the invention, there is provided a kit of parts for assembling a blind control unit, the kit including a chain guard housing as defined anywhere herein, a chain sprocket and a sprocket support. The kit of parts for the blind control unit may further include a drive bush, and/or an operating chain.

Additionally or alternatively, the kit of parts may include a clutch, suitably a wrap spring clutch, adapted to be operatively located in use between the chain sprocket and a drive bush.

In an embodiment of the fifth aspect, the chain guard housing and the sprocket support form a one-piece unit. Thus, the chain guard housing may form a part of the sprocket support.

Moreover, the invention may provide a kit of parts for assembling a roller blind. Thus, according to a sixth aspect of the invention, there is provided a kit of parts for assembling a roller blind, the kit including a blind control unit as defined anywhere herein, an idle end, a roller tube and a blind fabric or sheet. The kit may also include a pair of mounting brackets.

By the term “idle end”, it is meant an end of a roller blind which in use is rotatably coupled to a bracket and which is opposite to the control unit of the blind. The idle end typically includes an idle end bush adapted to engage one end of a roller tube and forms a bearing/axle arrangement with an idle end bracket which is adapted to allow the idle end of the roller tube to rotate relative to the idle end bracket.

The skilled person will appreciate that the features described and defined in connection with the aspect of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

FIG. 1 is an exploded perspective view of a control unit according to the invention;

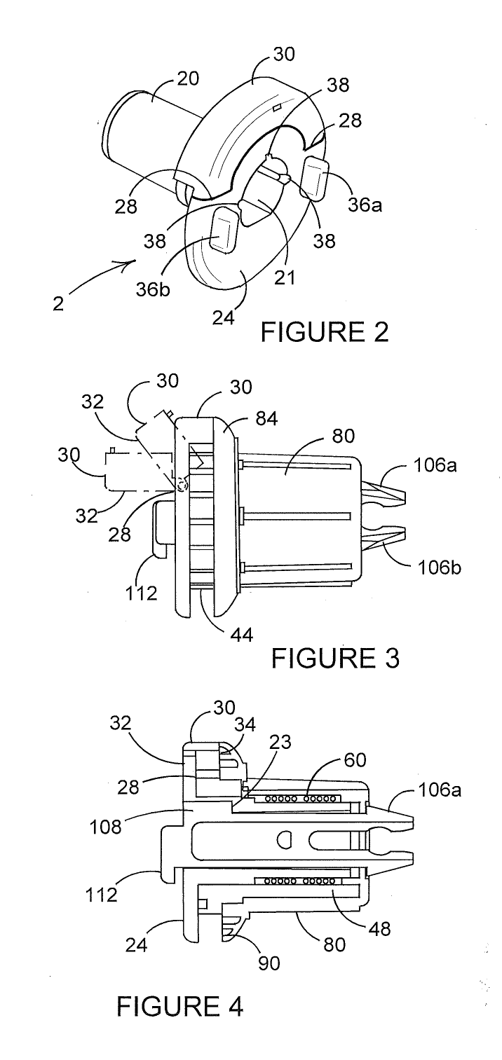

FIG. 2 is a perspective view from the rear of the sprocket support, showing the hinge portions;

FIG. 3 is a side elevational view of an assembled control unit showing the range of movement of the chain cover portion;

FIG. 4 is cross-sectional view of the assembled control unit of FIG. 3; and

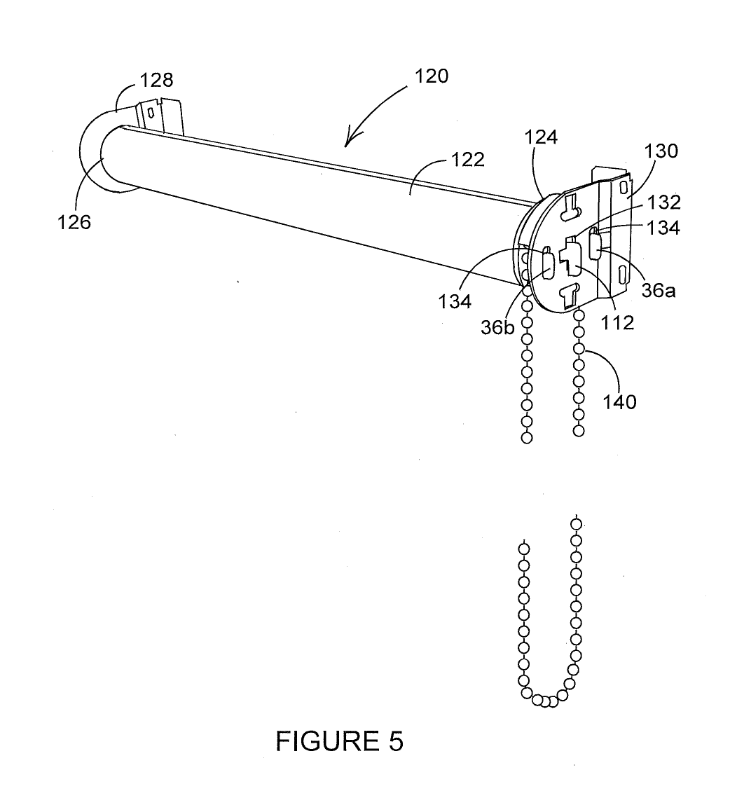

FIG. 5 is a perspective view of a roller blind assembly including a control unit according to the invention.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows an exploded perspective view of a control unit, which is formed from five basic components: a sprocket support 2, a chain sprocket 4, a wrap spring clutch 6, a drive bush 8 and a centre pin 10, which locks the other components together in use.

The sprocket support 2 comprises a clutch friction surface 20 and a sprocket bearing surface 22, both of which are in the form of cylinders which define a common bore 21. The sprocket bearing surface 22 has a slightly larger outer diameter than the clutch friction surface 20.

The end of the sprocket bearing surface 22 opposite to the clutch friction surface 20 terminates in a an end plate 24, which also acts as a body portion for a chain guard housing. The end plate 24 includes a pair of opposed hinges 28 which are located above a horizontal tangent from the uppermost portion of the common bore 21. The hinges 28 are formed at the outer periphery of the end plate 24. The inner edges of the hinges 28 (i.e. the edges closest to the central axis of the end plate 24) are linked by an arcuate cut-out 26, wherein the arc of the cut-out 26 is concentric with the peripheral edge of the end plate 24.

This arrangement defines a part annular section 32 of the end plate 24 which is spaced from the remainder of the end plate 24 and connected thereto by the two hinges 28. Projecting axially forward (i.e. towards the clutch friction surface as shown in FIG. 1) from the peripheral edge of the part annular section 32 is a chain cover element 30. The chain cover element 30 includes an axially projecting lug 34 which forms a first part of a locking arrangement.

The chain cover element 30 defines a covered configuration in which the part annular section 32 is arranged co-planar with the remainder of the end plate 24 (as shown in FIG. 1), and an uncovered configuration in which the part annular section 32 defines a plane which is angled with respect to the plane of the end plate 24 (shown by the hashed lines in FIG. 3).

FIG. 2 shows the sprocket support 2 from the rear. From this view, the hinge portions 28 can clearly be seen to be regions where the polymeric end plate 24 is thinner and shaped to act as hinges and permit the chain cover element 30 and associated part annular section 32 to rotate relative to the remainder of the end plate 24.

Also shown in FIG. 2 is a pair of rearwardly projecting locking tabs 36a, 36b, which are adapted to locate within corresponding apertures 134 of a mounting bracket 130 (see FIG. 5) to prevent rotation of the sprocket support 2.

Returning to FIG. 1, the chain sprocket 4 comprises a cylindrical body 40 which includes at one end thereof a sprocket wheel 42, which in turn defines an alternating series of teeth 44 and troughs 46 about its circumference. The teeth 44 and troughs 46 of the sprocket wheel 42 are sized and configured to engage with the balls of an operating chain in the form of a ball chain 140 (see FIG. 5), which is a common operating chain arrangement for roller blinds. Projecting axially from the opposite end of the cylindrical body 40 is a partially cylindrical clutch release element 48. The clutch release element 48 defines a cavity 52 within which is located the clutch friction surface 20 in use. The clutch release element 48 defines a pair of contact surfaces 50 along the longitudinal edges of the partial cylinder.

Located around the clutch friction surface 20 is the wrap spring clutch 6 which comprises a pair of helical springs 60a, 60b. The springs 60a, 60b are arranged to grip the clutch friction surface 20 in their rest configuration. Each spring 60a, 60b terminates in an outwardly turned tang 62a, 62b, 62c, 62d. Thus, the end portions of each spring project substantially radially outwardly. The angular spacing between the opposed tangs 62a, 62b, 62c, 62d of each spring is such that the tangs are located in use within the cut-out portion of the clutch release element 48 and the contact surfaces 50 are capable of engaging the respective tangs 62a, 62b, 62c, 62d.

Although two springs 60a, 60b are shown in the Figures and described herein, the skilled person will appreciate that a wrap spring clutch containing a single spring or more than two springs may be used instead. The concept of wrap spring clutches used in roller blinds is well known to those skilled in the art.

Encasing the wrap spring clutch is the drive bush 8. The drive bush 8 has a substantially cylindrical body 80 which defines a central aperture 82. The end 84 adjacent to the chain cover element 30 in use flares outwards such that the radius of the flared portion 84 matches that of the chain cover element 30. A second lock element in the form of an annular ring 90 (See FIG. 4) is provided in the face of the flared portion 84 which in use faces the end plate 24.

Projecting radially outwardly from the drive bush body 80 are a number of circumferentially spaced splines 86 arranged to engage radially inwardly facing projections (not shown) on a roller blind tube 122 (see FIG. 5). Such a splined bush arrangement is also common for roller blinds and is well known to those skilled in the art.

Projecting radially inwardly from the drive bush body 80 is a drive rib 88. The drive rib 88 is sized and configured to fit within the angular gap defined by the tangs 62a, 62b, 62c, 62d of the springs 60a, 60b, when the springs are arranged such that tangs 62a and 62c are axially aligned and the tangs 62b and 62d are axially aligned.

As noted above, the centre pin 10 holds the other components together. The centre pin comprises a cylindrical body 102 which terminates at one end in a pair of opposed legs 104a, 104b which are spaced apart. Each leg 104a, 104b includes a lug 106 at the distal end thereof. At the opposite end of the body 102 is located a head portion 108 in the form of a cylindrical portion having a greater diameter than the body 102. The transition between the body 102 and the head portion 108 defines a step 109. Three locking ribs 110 extend radially outwardly from the head portion 108 and engage in use with corresponding channels 38 (see FIG. 2) defined by the inwardly facing surface of the sprocket bearing 22 of the sprocket support 2.

Extending rearwardly from the head portion is a locking element 112 adapted to engage with a correspondingly shaped aperture of the mounting bracket 130 to prevent rotation of the centre pin in use.

To assemble the control unit, the sprocket 4 is slid over the sprocket support 2 such that the cylindrical body 40 of the sprocket 4 is capable of rotating about the sprocket bearing surface 22 and the sprocket wheel 42 is located adjacent to the end plate 24. In this way, the teeth 44 of the sprocket wheel 42 are covered by the chain cover element 30 when in its covered position as defined above.

The diameters defined by the two springs 60a, 60b are enlarged by urging the opposed tangs 62a, 62b, 62c, 62d circumferentially towards each other and the springs are axially slid onto the clutch friction surface 20 of the sprocket support 2, such that the tangs 62a, 62b, 62c, 62d are all located within the cut-out defined by the opposed contact surfaces of the clutch release element 48, with one pair of tangs 62a, 62c being located adjacent to one of the contact surfaces 50 and the other pair of tangs 62b, 62d being located adjacent to the other of the contact surfaces 50.

The drive bush 8 is then slid axially over the sprocket 4 and wrap spring clutch until the flared end portion 84 abuts the chain clover element 30. In this arrangement, the drive rib 88 is located within the arc defined by the tangs 62a and 62b of the spring 60a and within the arc defined by the tangs 62c and 62d of the spring 60b.

In order to retain all of the components in their correct configuration, the centre pin 10 is urged through the components from the sprocket support end. In doing this, the legs 104a, 104b of the centre pin 10 are deflected inwards to allow the centre pin 10 to pass through the common bore 21 of the sprocket support 2. The legs 104a, 104b also pass through the central aperture 82 of the drive bush 8 until the lugs 106 clear the distal end of the central aperture 82 of the drive bush, at which point, the legs 104a, 104b are able to snap back to their rest position. In their rest position, the lugs 106 prevent the withdrawal of the centre pin back through the components. In addition, the step 109 defined between the centre pin body 102 and the head portion 108 contacts a corresponding stop surface 23 (shown in FIG. 4) defined within the common bore 21 of the sprocket support 2 to prevent the centre pin 10 from passing all of the way through the common bore 21 of the sprocket support 2.

With the control unit thus assembled, the installer can now simply install the operating chain 140. In order to do this, the chain cover element 30 is rotated about the hinges 28 into an uncovered configuration, which exposes the teeth 44 of the sprocket wheel 42. This is shown in FIG. 3 by the hashed lines, which show a partially uncovered and a fully uncovered configuration. The operating chain 140 is then dropped onto the teeth from above. Once engaged with the teeth 44, the chain cover element 30 is rotated back about its hinges 28 to its covered configuration to cover the operating chain 140 and prevent its disengagement from the sprocket wheel 42. To prevent the chain cover element 30 unintentionally being moved to its uncovered configuration, the first lock element 34, located on the chain cover element 30, engages with the second lock element 90, carried by the drive bush 8. This arrangement requires the chain cover element 30 to be urged out of engagement with the drive bush 8 to move the chain cover 30 to its uncovered configuration, but still allows the drive bush 8 to rotate relative to the chain cover element 30 and sprocket support 2 when the chain cover 30 is in its covered configuration.

The operation of such a control unit is generally well understood by those skilled in the art. However, a brief description of its operation will follow, with reference to FIG. 5.

FIG. 5 shows a roller blind comprising the roller tube 122 around which a fabric is wound in use. Located at one end (the right hand end in FIG. 5) of the roller tube 122 is a control unit 124 as described above. Located at the other end of the roller tube 122 is an idle end 126, which is common to roller blinds and which forms a bearing/axle arrangement with a respective idle end mounting bracket 128, such that the roller blind 120 is rotatably coupled to the idle end mounting bracket 128.

The control unit 124 is supported by the control end mounting bracket 130 and engages the roller tube 122 via the drive bush 8. The mounting bracket 130 prevents rotation of the centre pin 10 and the sprocket support 2. More specifically, the mounting bracket 130 includes a central, cruciform shaped aperture 132 which in use receives the locking element 112 of the centre pin 10. The mounting bracket 130 also includes a pair of apertures 134 which are arranged to receive the locking tabs 36a, 36b. The engagement of the locking element 112 and the locking tabs 36a, 36b with their respective apertures 132,134 prevents rotation of the centre pin 10 and the sprocket support 2 with respect to the mounting bracket 130.

The roller blind tube 122 is adapted to receive thereon a roller blind fabric (not shown). The engagement of a roller blind fabric with the roller blind tube 122 is entirely conventional and well known to those skilled in the art. The blind fabric may be deployed (i.e. the blind lowered) or retracted (i.e. the blind raised) by rotation of the roller tube 122 via rotation of the operating chain 140 in the conventional way.

An operator rotates the operating chain 140 in one sense, which in turn rotates the sprocket wheel 42 and the sprocket 4. The relevant contact surface 50 of the clutch release element 48 contacts the two tangs 62a, 62b, 62c, 62d adjacent to it and urges them to rotate against the resistive frictional forces between the springs 60a, 60b and the clutch friction surface 20. By rotating the tangs 62a, 62b, 62c, 62d in this way, the grip of the springs 60a, 60b on the friction surface 20 is reduced and the springs 60a, 60b are able to rotate about the friction surface 20.

The rotation of the springs 60a, 60b in turn causes the drive bush 8 to rotate via the contact between the tangs 62a, 62b, 62c, 62d and the drive rib 88. Finally, rotation of the drive bush 8 causes rotation of the roller tube 122 which is engaged therewith.

When the operating chain 140 is not being rotated, the clutch formed by the friction between the springs 60a, 60b and the clutch friction surface 20 prevents unwanted rotation of the roller tube 122. In fact, the weight of the blind fabric acting downwards and attempting to rotate the roller tube 122 in a corresponding sense, causes the drive rib 88 of the drive bush 8 to contact the tangs 62a, 62b, 62c, 62d of the springs 60a, 60b. However, the force exerted by the drive rib 88 on the tangs 62a, 62b, 62c, 62d causes the springs 60a, 60b to grip the friction surface 20 more strongly and thus prevents rotation of the control unit 124 by the action of the fabric weight.

1-11. (canceled)

12. A chain guard housing for a blind, the housing including a body portion and a chain cover portion hingedly coupled to the body portion, whereby the chain cover portion is capable of being rotated about the hinge out of alignment with a chain sprocket.

13. The chain guard housing according to claim 12, wherein the body portion defines an aperture sized and configured to receive therein a centre pin.

14. The chain guard housing according to claim 12, wherein the chain cover portion has a covered configuration in which at least part of the chain cover portion overlies a portion of a chain sprocket and an uncovered configuration in which it is spaced from the chain sprocket and the chain cover portion includes a first lock element adapted to releasably retain the chain cover portion in the covered configuration.

15. A blind control unit including a chain sprocket, a sprocket support and a chain guard housing, wherein the chain guard housing includes a body portion and a chain cover portion hingedly coupled to the body portion, whereby the chain cover portion is capable of being rotated about the hinge out of alignment with the chain sprocket.

16. The blind control unit according to claim 15, wherein the body portion defines an aperture sized and configured to receive therein a centre pin.

17. The blind control unit according to claim 15, wherein the chain cover portion has a covered configuration in which at least part of the chain cover portion overlies a portion of the chain sprocket and an uncovered configuration in which it is spaced from the chain sprocket and the chain cover portion includes a first lock element adapted to releasably retain the chain cover portion in the covered configuration.

18. The blind control unit according to claim 15, wherein the control unit further includes a clutch adapted to permit torque to be transmitted from the chain sprocket.

19. The blind control unit according to claim 15, wherein the chain guard housing and the sprocket support together form a one-piece unit.

20. The blind control unit according to claim 15, wherein the blind control unit further includes a drive bush operatively coupled to the chain sprocket, the drive bush being adapted to engage a roller tube.

21. The blind control unit according to claim 20, wherein the drive bush cooperates with the chain guard housing to prevent disengagement of an operating chain from the chain sprocket.

22. A roller blind including a control unit, an idle end and located therebetween a roller tube carrying a blind fabric or sheet, wherein the control unit includes a chain sprocket, a sprocket support and a chain guard housing, and wherein the chain guard housing includes a body portion and a chain cover portion hingedly coupled to the body portion, whereby the chain cover portion is capable of being rotated about the hinge out of alignment with the chain sprocket.

23. The roller blind according to claim 22, wherein the chain guard housing body portion defines an aperture sized and configured to receive therein a centre pin.

24. The roller blind according to claim 22, wherein the chain cover portion has a covered configuration in which at least part of the chain cover portion overlies a portion of the chain sprocket and an uncovered configuration in which it is spaced from the chain sprocket and the chain cover portion includes a first lock element adapted to releasably retain the chain cover portion in the covered configuration.

25. The roller blind according to claim 22, wherein the control unit further includes a clutch adapted to permit torque to be transmitted from the chain sprocket.

26. The roller blind according to claim 22, wherein the chain guard housing and the sprocket support together form a one-piece unit.

27. The roller blind according to claim 22, wherein the blind control unit further includes a drive bush operatively coupled to the chain sprocket, the drive bush being adapted to engage the roller tube.

28. The roller blind according to claim 27, wherein the drive bush cooperates with the chain guard housing to prevent disengagement of an operating chain from the chain sprocket.
